(19) United States
(12) Patent Application Publication
(10) Pub. No.: US 2024/0311388 A1
(43) Pub. Date: Sep. 19, 2024

(54) WEB-BASED TOOL FOR STREAMLINED AND INTEGRATED DATA COLLECTION, ANALYSIS, AND REPORTING

(71) Applicant: Israel Terungwa Agaku, Flint, MI (US)

(72) Inventor: Israel Terungwa Agaku, Flint, MI (US)

(21) Appl. No.: 18/110,919

(22) Filed: Feb. 17, 2023

(51) Int. Cl. G06F 16/25; G06F 9/451; G06F 16/28

(52) U.S. Cl. CPC G06F 16/254; G06F 9/453; G06F 16/285

(57) ABSTRACT

This disclosure relates generally to a system and method for the optimized management of data gathering, data sampling and data analysis. A computer-controlled system coordinates and controls workflow to receive, sequence, process, analyze and track various types of data in the most efficient path thereby minimizing errors and providing prompt output. The system involves a smartphone, a laptop computer, a portable communicating device, a cloud computing device, or a data storage device participating in the process. The proposed method reduces errors and provides quick, clear, and efficient data results and follow-up features. In order words, it makes data gathering, data sampling and data analysis a breeze.

### BACKGROUND

### Field of the Invention

Embodiments relate to data processing systems and more particularly to a web-based tool for streamlined and integrated data collection, analysis, and reporting.

### Description of the Related Art

Surveys are a powerful tool for gathering a wide range of data and insights from a large number of people in a short period of time. They can be used for research, evaluation, decision-making, and marketing purposes, and can help to better understand the experiences, attitudes, and behaviors of the people being studied. Surveys are an important tool for gathering information and feedback from stakeholders, and can be used to inform research, evaluation, and decision-making processes. They are a valuable resource for businesses and organizations seeking to understand customer preferences and satisfaction, as well as market trends. Overall, the use of surveys is crucial for gathering a wide range of information and insights that can inform various efforts and decision-making processes.

Data collection over the web is an important tool for organizations because it allows them to reach a wide and diverse audience, is generally low cost, is convenient for both the organization and the respondents, and can provide real-time data. It is also generally easy to use, involving the creation of an online survey or questionnaire that respondents can complete on their own devices. The wide reach and low cost of data collection over the web make it an attractive option for organizations looking to gather large amounts of data on a budget, and the convenience and real-time nature of the data collected can be especially useful for organizations that need to make timely decisions.

There are many platforms available for creating and conducting surveys, such as SurveyMonkey, Google Forms, Typeform, Qualtrics, SurveyGizmo, SoGoSurvey, Zoho Survey, QuestionPro, SurveyPlanet, and JotForm. These platforms offer various features and functionality, but they all have limitations that the current innovation aims to address. The current approaches to collecting information from web-based surveys is highly fragmented. Users must file a separate application for ethical review, then launch the survey on a different platform, then analyze the data yet on another platform. These tools were primarily designed for market research rather than scientific or academic research. Market research refers to the process of gathering data and insights about consumers and market trends in order to inform business decisions. In contrast, scientific research and academic research are typically more rigorous and are designed to answer specific research questions or test hypotheses. They often involve more complex sampling and data collection methods, as well as more advanced statistical analyses. As such, SurveyMonkey and similar existing tools may not be the best choice for scientific or academic research projects that require more sophisticated methods and analyses.

The web-based survey platforms such as SurveyMonkey do not offer seamless integration with institutional review boards (IRBs), which can make it more difficult for researchers to obtain ethical approval and can lead to a fragmented process. IRBs are committees responsible for reviewing and approving research projects involving human subjects in order to ensure the protection of their rights and welfare. Without seamless integration, researchers must navigate multiple systems and processes in order to obtain ethical approval and collect data, which can be inefficient and pose challenges.

The currently offered platforms provide limited support for multimedia. The current platforms have only limited options for including multimedia in surveys, such as the ability to embed video or audio files. Google Forms is a free, web-based survey creation tool that allows users to include audio links in their surveys, but it does not have the capability to record audio or video directly and does not offer automatic transcription. Qualtrics and SurveyGizmo are paid survey creation platforms that offer a range of features for creating and collecting responses to surveys, including “Audio Recording” and “Video Recording” question types that allow respondents to record audio and video directly in the survey but neither offer automatic transcription. SurveyMonkey is a web-based survey software that allows users to create surveys and collect responses online, but it does not have the capability to record audio or video directly and does not offer automatic transcription. Survey Monkey only allows users to include audio and video links in their surveys, which respondents can click on to listen to or watch.

The recording or creating composite variables in SurveyMonkey can be a laborious and time-consuming process, especially if the survey has a large number of questions or a complex design. This is because it requires users to manually edit the survey design and specify the new values or categories for each response. This can be a tedious and error-prone process, especially if the survey has a large number of responses or a complex structure.

Also, the Data collection tools, such as SurveyMonkey, are designed specifically for collecting data from surveys and do not have the capability to develop a manuscript for publication in a scientific journal or other publication. These tools have limited capabilities for basic analysis, such as descriptive statistics, but are not equipped to handle advanced analysis such as weighted multivariate methods. Overall, basic analytical capacity refers to the most basic or fundamental tools and features for data analysis, and may not be sufficient to meet the needs of more complex or advanced data analysis projects. For example, basic analytical capacity may not include advanced statistical analysis tools or sophisticated data visualization options, which can be critical for certain types of data analysis. This can limit the usefulness of the platform for data analysis and decision-making. As a result, users must export their collected data to other tools or resources, such as a word processing program and statistical analysis software, in order to organize, analyze, and present the data in a clear and coherent manner in a manuscript. This limitation can make it difficult for users to effectively turn their collected data into a publishable manuscript.

Furthermore, the Paying incentives are not seamlessly integrated into many web data collection platforms, presenting a challenge for researchers who want to offer incentives to encourage participation in their studies. There are several reasons for this, including the fact that different platforms have different payment processing systems and may not be able to seamlessly integrate incentives into their surveys. Additionally, offering incentives can raise ethical concerns, such as influencing participants' responses or creating a conflict of interest, which may cause some platforms to avoid offering incentives altogether. While it can be challenging to offer incentives in web-based studies, some platforms, such as SurveyMonkey, do allow for external payment processing or non-monetary rewards, and researchers can also use other methods, such as randomly drawing from a pool of eligible participants or offering incentives through an external system. It is important to carefully consider the ethical implications of offering incentives and choose a method that is appropriate for the study.

There are also multiple notables problems with the fragmentation of the processes before, during, and after data collection. Fragmentation in this context refers to the presence of multiple, disconnected systems or tools that are used for these tasks, rather than a single, integrated platform. This can lead to a number of challenges, including:

The Fragmentation of the Institutional Review Board (IRB) system and data collection system can lead to inefficiencies and duplicative efforts. For example, even though the survey instruments may already have been developed on the data collection platform, they may still need to be converted into a separate format that is required by the stand-alone IRB. This fragmentation of the IRB system and data collection system can thus lead to inefficient workflows, as researchers may need to manually transfer data or documents between systems or may be unable to take advantage of automation or other efficiencies that an integrated platform could provide.

The Fragmentation of the IRB system and data collection system can also make it difficult for IRB to track the progress of a research project or to understand how data is being collected and analyzed, leading to a lack of transparency and accountability.

Furthermore, when data is collected and analyzed using multiple disconnected systems, this could be time-wasting and may introduce errors from having to convert between formats. Due to the necessity to manually move data across systems or the inability to take advantage of automation or other advantages that an integrated platform could bring, inefficient workflows can also result from a fragmented data-gathering and analysis process.

The current invention proposes a system where a new approach, utilizing the best of breed in existing technologies, to revolutionize the digital arena, implementing the bridge that fills the gap between data collection, sampling, and analyzing methods.

The proposed platform seeks to significantly simplify the whole process and efficiently manage the circumstances through its swift ability to digitalize the whole process. The invention relates to the development of an automated compounding system that addresses the needs and desires of simple to complex scenarios. The system encompasses computer communications network-based systems, software, and various input and output stations in order to provide the desired output. The system also aims to present multiple additional features which can provide an advanced level of ease, error elimination and instant results.

As per applicants' knowledge, none of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of an ecosystem that allows for the free flow of information and access for authorized users across its various platforms, which enables efficient execution of scientific tasks and eliminates the need to collect the same information repeatedly.

It is also the objective of the invention to provide a simplified process of multiple platforms including a platform for sampling and sample size calculation, a platform for submitting study protocols for ethical review by an affiliated Institutional Review Board (IRB), a questionnaire design and online data collection platform, a data analysis and visualization platform, a platform called CollaboWrite for developing manuscripts, and a platform for downloading publicly available datasets that have been processed and cleaned.

It is moreover the objective of the invention to provide a system that offers a wide range of tools and features for conducting research, including the ability to calculate sample sizes, implement various sampling methods, design and launch surveys, analyze and visualize data, and access pre-cleaned datasets.

It is also the objective of the invention to provide a system where the process of signing in and validation into the web platform involves accessing the platform's login page, entering your login credentials (username or email address and password), submitting login credentials by clicking on a login button or pressing the “Enter” key, and being granted access to the platform if login credentials are correct.

It is moreover the objective of the invention to provide a platform, where if the user's login credentials are incorrect, the user may be prompted to try again or you may be shown an error message. Once user has successfully logged in and been validated, he/she will be able to access the platform and use its features and functions.

It is further the objective of the invention to provide a dual and reliable system that is easy to install and is easily compatible with all types of smart devices and provides secure electronic transmission.

It is moreover the objective of the invention to provide a system that is in line with the latest technologies and utilizes the latest methods including but not limited to a real-time environment, a highly compatible and intelligent system is introduced.

It is further the objective of the invention to provide an interface that is easy to use, and where new users are provided with tutorials and necessary guidance to use the system.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment discloses a new approach, toward data management and analysis system.

The current invention as per its preferred embodiments provides a system ecosystem that allows for the free flow of information and access for authorized users across its various platforms, which enables the efficient execution of scientific tasks and eliminates the need to collect the same information repeatedly. These platforms include a platform for sampling and sample size calculation, a platform for submitting study protocols for ethical review by an affiliated Institutional Review Board (IRB), a questionnaire design and online data collection platform, a data analysis and visualization platform, a platform called CollaboWrite for developing manuscripts, and a platform for downloading publicly available datasets that have been processed and cleaned.

The system as per its preferred embodiments provides a login system that will require the creation of user accounts, each of which has a unique username and password. When a user wants to access the platform, they enter their username and password, which are checked against the stored account information to verify the user's identity. If the login credentials are correct, the user is granted access to the platform. If the login credentials are incorrect or the account does not exist, the user is denied access.

The system as per its preferred embodiments provides capabilities to collect data both cross-sectionally (one single snapshot in time) and longitudinally (stream of snapshots over time).

The system as per its preferred embodiments provides innovative solution to all the problems with live audio and video recording and transcription. In addition to file uploads, this platform will offer a number of innovative features that are not currently available on other survey platforms. These features could include live audio and video recording, a feature that allows users to record audio and video directly in the survey, using the user's device's microphone and camera. The recordings will be automatically uploaded to the platform's servers as they are being recorded, allowing users to review and edit the recordings as needed. This feature would be a significant improvement over current platforms that do not offer live audio and video recording, and which only allow users to include audio and video links in their surveys. In addition to recording, the platform will use machine learning algorithms and natural language processing (NLP) techniques to automatically transcribe the audio and video recordings as they are being uploaded. This will be done using APIs from companies such as Google Cloud Speech-to-Text, IBM Watson Speech-to-Text, or Microsoft Azure Speech Services. This feature will be a major advancement over current platforms that do not offer automatic transcription, and which require users to manually transcribe their recordings if they want to include transcription in their survey. Finally, the platform will also allow file uploads, a feature that allows users to attach files such as images, documents, and videos to their responses.

The system as per its preferred embodiments provides system for inviting collaborators to the project: Collaboration is an important aspect of many research projects, and a system for inviting and managing collaborators can help streamline the process and ensure that everyone is kept informed and up-to-date on the project. This component of the platform might include features such as the ability to invite collaborators by email, the ability to assign tasks or roles to different collaborators, and the ability to track the progress of the project as a whole.

The system as per its preferred embodiments provides system for designing questionnaires with a user-friendly interface: A well-designed questionnaire is an important tool for collecting accurate and reliable data. A user-friendly interface can help make the questionnaire creation process easier and more efficient, and can also help ensure that the questionnaire is more likely to be completed by study participants. This component of the platform might include features such as the ability to create questions using a variety of different question types (e.g., multiple choice, open-ended, etc.), the ability to customize the look and feel of the questionnaire, and the ability to preview the questionnaire to see how it will look to study participants.

The system as per its preferred embodiments provides an integrated system for the ethical review of the study: Ethical considerations are an important aspect of any research study, and an integrated system for ethical review can help ensure that the study meets all necessary ethical standards and guidelines. This component of the platform might include features such as the ability to submit an ethical review application and any supporting documents, the ability to track the progress of the review process, and the ability to receive feedback and suggestions from the review committee.

The system as per its preferred embodiments provides an integrated system to offer financial incentives to study participants: Financial incentives can be a useful tool for encouraging participation in a study, and an integrated system for offering these incentives can help streamline the process and ensure that participants are properly compensated.

The system as per its preferred embodiments provides an integrated system to launch the survey on the platform or retrieve a web link to share on other platforms: An integrated system for launching and distributing the survey can help make the process of collecting data more efficient and convenient and can help ensure that the data is collected in a consistent and standardized manner. This component of the platform might include features such as the ability to send emails or text messages to study participants with a link to the survey, the ability to embed the survey on a website or other platform, and the ability to track the progress of the survey as it is completed by participants.

The system as per its preferred embodiments provides a method to automatically access data codebooks and survey methodology reports: Data codebooks and survey methodology reports provide important information about the data collected in a study, and a system for automatically accessing these resources can help researchers quickly and easily understand and analyze the data. This component of the platform might include features such as the ability to download codebooks and methodology reports as PDF or other file formats, the ability to search for specific information within the codebooks and reports, and the ability to view or download related data files.

The system as per its preferred embodiments provides a mechanism for automated analysis of data and writing of the manuscript: From the data collection module, users can select “Analyze only”, or “Analyze and Write”. Automated analysis tools are available to help streamline the process of analyzing data and can help researchers quickly and easily identify trends and patterns in the data.

This component of the platform might include features such as the ability to apply statistical analysis techniques to the data, the ability to create graphs and charts to visualize the data, and the ability to generate reports or summaries of the data. If users select “Analyze and write”, they are routed to another part of the platform (“CollaboWrite”) that supports scientific writing using a great deal of automation for both the data analysis and the writing. This integration with CollaboWrite to develop scientific manuscripts in real time can help streamline the publication process and can help researchers more quickly and easily disseminate their findings to the broader scientific community.

The system as per its preferred embodiments provides encryption to ensure that protected health information is encrypted when it is transmitted over the internet or stored electronically, the platform will include features such as Secure Sockets Layer (SSL) or Transport Layer Security (TLS) encryption for data in transit, and encryption of data at rest using technologies such as Advanced Encryption Standard (AES) and Rivest-Shamir-Adleman (RSA).

The system as per its preferred embodiments provides Data export and import. Data from the platform can be exported into a dozen other formats. Data can also be imported from a variety of formats.

The system as per its preferred embodiments provides merge and append features. A sophisticated concatenation system will be built that allows both merge and append. In programming and data analysis, “merge” and “append” refer to operations for combining multiple pieces of data or datasets. A “merge” operation combines multiple data structures or datasets based on common keys or identifiers, resulting in a single, combined dataset. An “append” operation simply adds the rows from one dataset to the end of another dataset, resulting in a concatenated dataset with all the rows from both original datasets. Both merge and append operations can be useful for combining related data for analysis or visualization. In most of the existing platforms, the merge procedure implemented is a simple case where only individual-level unique IDs are used. In the new platform, complex merge procedures will be possible that use individual-, family-, and household-level unique identifiers where present.

The system as per its preferred embodiments provides advanced and innovative approaches to recode single variables and generate composite variables from two or more variables. Users will be able to choose from two approaches whenever they want to recode a single variable or generate a composite variable from two or more variables. The first approach is the “classic” method which involves defining the categories of the variable being created using drop down menus that select conditions from the parent variable. The second approach is the “visual” or “dynamic” method which allows the user to simply drag and drop within and across the levels of the desired variables. This platform will be the first ever to implement such a dynamic approach to data analysis.

The first step as per its preferred embodiments is pre-data collection activities. The main step before data collection is ethical review by an institutional review board. Users can get to the IRB module directly; alternatively, if they first go to “Launch Survey” module, the first question they are asked is whether ethical review is needed. If they answer ‘Yes’, then, they are routed to the IRB module to begin from there. The Chisquares platform has an IRB affiliated with it thus allowing for seamless application, tracking and approval. Both the application by the user, and the review process by members of the IRB take place on the platform allowing for progress to be tracked in real time. On the user side, they can file an initial application for review, as well as extend, close, modify, discontinue, or report issues with a current application. On the IRB side, they can initiate premature termination of a study if there are indications for it. The IRB module allows a user to automatically develop the key documentation required for IRB review, namely, a study protocol, an informed consent form, and the study questionnaire. Once these materials are developed, they can either submit to the IRB affiliated with the Chisquares platform, or they can download the generated documents in pdf format and submit to another IRB of their choice.

The process for submitting and responding to an Institutional Review Board (IRB) for research ethics involves several steps. First, researchers must prepare a protocol and informed consent form for their study. The protocol should describe the research question, study design, recruitment and consent process, data collection and analysis, and any potential risks or benefits to participants. The informed consent form should outline the purpose of the study, any procedures that will be performed, and any potential risks or benefits to participants. On the platform, the protocol is automatically generated once the user completes the form. The informed consent form is provided in the form of a template which is completed by the user. It is also possible that the user may have developed their own consent form on another system; in this case, they can upload that version by clicking “External Upload & Skip”. Furthermore, If in the previous page for the study overview, the user had indicated that the study involved children, an assent form will automatically be generated and the user would have to complete this as well (or select skip if not applicable, e.g., studies of newborns).

Next, the researcher develops the questionnaire to be submitted along with their protocol and informed consent form to the IRB for review. The questionnaire development tools on the platform are very sophisticated and allow the user to upload videos, audios, or other files as part of the question. They also allow the user to either upload or live record a picture, audio or video as part of their response. For a user who only wants to submit the protocol for IRB without any further intentions of collecting data on the platform, they can upload an external version of the questionnaire by clicking “External Upload & Skip”. Once submitted, the user can track the status of their IRB application(s).

The IRB is responsible for reviewing the protocol to ensure that it meets ethical standards and that the rights and welfare of participants are protected. The IRB may request revisions to the protocol or informed consent form or may request additional information before making a decision.

If the study is approved, the researcher may begin recruiting participants and conducting the study. However, the IRB may require the researcher to submit progress reports or modifications to the protocol throughout the study.

Continuation IRB is a process for reviewing ongoing research studies to ensure that they continue to meet ethical standards. Researchers may be required to submit continuation IRB applications if there are significant changes to the protocol or if the study is extended beyond its original timeline.

When the study is completed, the researcher should submit a closeout report to the IRB, outlining the final results of the study and any implications for future research. The IRB may also require the researcher to submit a final report to the funding agency or to publish the results in a scientific journal.

In some cases, the IRB may decide to terminate a study if it is determined that the research is not being conducted in accordance with ethical standards or if there are significant risks to participants. The researcher may also request that the study be terminated for any number of reasons, including inadequate recruitment or unanticipated issues with the study design.

As shown in the approval notice below from the U.S. Department of Health and Human Services, Datasios LLC, the parent company of Chisquares, has been granted approval to operate as a private Institutional Review Board. Members of this IRB are composed of individuals who are independent of the research being reviewed and have no conflicts of interest. This means that the members of the IRB do not have any personal or financial interests that could influence their decision-making regarding the review of a particular research study. To ensure independence and avoid conflicts of interest, the Datasios IRB has policies in place that prohibit members from reviewing studies in which they have a personal or financial stake. In addition, all members of the IRBs are required to disclose any potential conflicts of interest and have to recuse themselves from the review process if a conflict is identified. These measures are put in place to ensure that the IRB is objective and unbiased in its review of research protocols and that the rights and welfare of participants are protected. All of the process for submission, review, and approval of ethical review takes place exclusively on the platform. Once a user submits an IRB application, both the IRB chair and the IRB coordinator receive an email notification. All co-authors also receive a similar notification.

Institutional Review Boards (IRBs) are responsible for reviewing research protocols to ensure that they meet ethical standards and that the rights and welfare of participants are protected. There are two main types of IRB review and both are enabled on the platform from the IRB portal: expedited review and full board review. The type of review that is conducted depends on the level of risk to participants and the type of research being conducted. Selection of certain buttons one the IRB intake form automatically triggers a full IRB review (e.g., research involving women, pregnant children, or other vulnerable populations).

Expedited review is a process for reviewing research protocols that pose minimal risk to participants. Expedited review can be conducted by a single IRB member or a small group of IRB members who are qualified to review the specific type of research being proposed. The IRB member(s) review the protocol and make a decision about whether the study can proceed without the need for full board review.

Full board review is a process for reviewing research protocols that pose greater than minimal risk to participants. Full board review involves the entire IRB, which is composed of at least five members who are qualified to review the specific type of research being proposed. The full board reviews the protocol and makes a decision about whether the study can proceed.

The IRB coordinator is a staff member who works with the IRB chair to facilitate the IRB review process. The IRB coordinator is responsible for managing the IRB review process, including scheduling meetings, preparing agendas, and tracking deadlines. The IRB coordinator may also provide guidance to researchers on how to prepare their protocol and informed consent form for IRB review.

The IRB chair is responsible for leading the IRB review process and making final decisions about whether a study can proceed. The IRB chair is responsible for ensuring that the IRB operates in accordance with ethical standards and relevant regulations, and for overseeing the work of the IRB coordinator and other IRB members.

On the Chisquares platform, a submitted IRB application is immediately routed directly to a designated email which is accessible by both the IRB Chair and the IRB coordinator (the latter just to ensure review is done in a timely manner). Both individuals receive notification of a new submission via email and on logging to the Chisquares platform, they can also see an alert of a new IRB submission. The IRB chair does a preliminary review of the application and decides whether to perform an expedited review or convene the full IRB. The platform has capabilities for IRB members to recommend approval or rejection of a proposal, and provide additional comments. The IRB chair makes the final decision and sends the final letter to the applicant. The letters are pre-drafted letters with elements of softcoding to reflect the name and number of the project, as well as to capture all the comments provided during the review. The IRB chair can edit the letter before sending it.

Members of the IRB can switch roles to become “authors” or investigators themselves should they want to submit an ethics application of their own. The switch button at the top allows them to make this transition seamlessly.

To launch the survey, the user must select whether the data will be captured cross-sectionally or longitudinally. Cross-sectional and longitudinal studies are two different approaches to collecting data from a population. A cross-sectional study involves collecting data from a population at a single point in time, while a longitudinal study involves collecting repeated data from the same population over an extended period of time. If the user selects a longitudinal data collection, then they have to specify two parameters: (1) who is to be followed (2) how frequently

To allow respondents to be contacted again, they will be asked at the end of their survey whether they want to participate in the next wave. If a respondent agrees to be followed up and provides their email, this email can be used to identify the respondent in the future survey and to link the two survey waves.

To ensure the survey remains anonymous, the email will be masked from the released dataset by replacing it with a unique identifier (a hash function that converts the respondent's personal information into a unique identifier). Masking is an effective way to preserve the anonymity of respondents in a survey, as it makes it impossible to determine the identity of individual respondents from the released data. While masking can protect respondent anonymity, it is still possible to contact respondents at a later date if they have agreed to be followed up and provided their email. This is done on the platform by creating a mapping between the respondent's personal information and the unique identifier generated by the masking process, and storing this mapping in a secure database. This allows the system to identify and contact the respondent at a later date while still preserving their anonymity in the released data.

For both cross-sectional and longitudinal studies, users can offer incentives to increase response rates. Incentives are operationalized on this platform using a raffle draw system as follows:

Determine the sample size: The user would be asked the number of respondents they plan to include in the sample.
Assign a unique identifier to each respondent: Each respondent would be assigned a unique number when they complete the survey. The identifiers will be assigned in numerical order, starting with the lowest number (1) for the first respondent and increasing by one for each subsequent respondent.
Calculate the middle of the sample size: The middle of the sample size would be calculated by dividing the sample size by two and rounding up to the nearest whole number. For example, if the sample size is 100, the middle of the sample size would be 51.
Select the winner: The respondent with the unique identifier that matches the middle of the sample size would be the winner. In the example above, the respondent with the unique identifier of 51 would be the winner.
Notify the winner: When the respondent clicks to end the survey, a pop-up notification would appear showing them their winning number and telling them that they won. The notification would include instructions for claiming the prize, such as visiting a specific URL or following a set of instructions on the survey platform.
Claim the prize: The winner could claim the prize by following the instructions provided in the notification and providing their unique identifier as proof of their claim. This could help to verify that they are the true winner and are entitled to the prize.

This approach would allow for the selection of a raffle draw winner and notifying them of their win without collecting or storing the respondent's personal information. It would still be necessary to provide the winner with instructions for claiming the prize, but there would be no need to collect or store their contact information or other personal information in order to do so. PayPal's API (Application Programming Interface) will be used to automate the payment process. The API will be integrated into the platform and allow for a custom solution for transferring the prize to the winner automatically when they complete the survey and provide their email.

For both cross-sectional and longitudinal data collections over the web, the user must select one of two modes to send the survey questionnaires to their target audience: via emails (must be provided), or they can access a sharable link. By clicking on the first option allows the user to either paste or upload emails. Clicking on the second option creates both a url as well as a bar code which can be shared. After the launch of the study, the user can manage the study through a plethora of tools. These include the following:
1. Download study codebook: While many data collection software platforms offer basic documentation of their variables, this feature allows users to access a more comprehensive codebook, including detailed information on definitions and coding schemes.
2. Download study report: While some data collection software platforms may offer basic summary statistics, this feature allows users to download a more in-depth report on the results of the survey, complete with data visualizations and advanced statistical analysis.
3. Download basic tabulations of all variables: While many data collection software platforms offer basic summary statistics, this feature allows users to download a more detailed summary of the data, including counts, percentages, and means for each variable, as applicable.
4. View response rates: While some data collection software platforms may offer basic metrics on participation, this feature allows users to view the response rate for the survey, which can be more informative for assessing the reliability of the results.
5. Share data: Many data collection software platforms do not offer the ability to share data with others, but this feature allows users to export the data or provide access to it through a secure online portal.
6. Initiate research manuscript writing: Most data collection software platforms do not offer tools for writing a research manuscript, but this feature allows users to easily create a scientific manuscript using the CollaboWrite module.
7. This functionality allows users to invite additional participants to participate in the survey. This could involve sending out email invitations or creating a public link to the survey that can be shared with others.
8. Change study timeline: Many data collection software platforms do not offer the ability to adjust the timeline of a study, but this feature allows users to change the start and end dates, the frequency of data collection, and other aspects of the study design.
9. Close out study: Most data collection software platforms do not provide a way to end a study and close the survey to new participants, but this feature allows users to do so by archiving the data and deactivating the survey link.
10. Financial incentives tracker: This feature is not commonly found on data collection software platforms, but it allows users to track any financial incentives offered to participants in the survey, including payments or rewards.
11. Invite co-investigators: this feature allows the user to invite other researchers or stakeholders to join the project as co-investigators or advisors.
12. View survey participants' messages: Most data collection software platforms do not offer the ability to see messages or feedback provided by participants, but this feature allows users to view any comments or suggestions that have been submitted through the platform.
13. Send reminder to nonrespondents: This functionality allows users to send a reminder to participants who have not yet completed the survey, in an effort to increase the response rate. This could involve sending an email or a message through the survey platform, or using other methods of communication. There are also elaborate storage systems for collecting data as well as different ways of communicating with co-authors. In the progress dashboard, the user can view the numbers recruited and their demographics.
   After data collection, the user can choose to Analyze their data in the ‘Analysis’ Module or to analyze and write in the ‘CollaboWrite’ module. Both Analysis and CollaboWrite modules contain similar cutting-edge analytical capabilities, but each has some unique features. For example, the Analysis module has additional data visualization features far beyond what is in the Collabo Write module. In turn, the Collabo Write module has features for automated development of manuscripts.

### Novel Features of Collabo Write

As a platform for automated writing of scientific manuscripts, Collabo Write includes the following features:
Word processor: This feature would allow users to write and edit the text of their scientific manuscript in a familiar, easy-to-use interface, similar to a word processor.
Table generation: This feature would allow users to generate tables based on their data and automatically insert them into the manuscript. It could also allow users to turn generated tables into text automatically, making it easier to incorporate tables into the text of the manuscript.
Reference management: This feature would allow users to manage and organize their references, including adding, deleting, and editing references as needed. It could also include features such as automatic formatting of references in the style required by the journal and the ability to import references from databases or other sources.
Co-author contributions: This feature would allow users to track the individual contributions of co-authors, including which sections of the manuscript each co-author has written or reviewed. It could also allow users to assign specific tasks or responsibilities to co-authors and track the progress of these tasks.
ICMJE forms: This feature would allow users to complete the required forms for authorship and submission to a journal, such as the International Committee of Medical Journal Editors (ICMJE) forms. It could also include features such as automatic validation of the forms to ensure they are completed correctly.

Overall, CollaboWrite allows for the automated writing of scientific manuscripts using the data collected by the user. It provides a range of useful features to help researchers efficiently write, organize, and submit their manuscripts, while also helping to ensure compliance with the requirements of the journal and the ICMJE.

The platform as per its further embodiments provides a system for guiding users through the process of selecting the appropriate statistical test or technique or for specifying the type of variables they have. This approach is novel compared to current systems, as it is specifically designed to be user-friendly and intuitive for lay users who may not have a strong background in statistics or data analysis. This system for guiding lay users through statistical testing involves the following steps:
Variable selection: The user would first be prompted to select the variables they want to test.
Variable type: The user would then be asked to specify the type of variables they have selected, such as two continuous variables, two count variables, one continuous and one categorical, or two categorical variables, etc.
Test recommendation: Based on the type of variables selected and the dataset's sample size which is automatically detected, the platform would recommend a statistical test that is appropriate for those variables and the sample size (i.e., parametric or non-parametric). For example, if the user has selected two continuous variables for a dataset with more than 30 participants, the platform might recommend a paired t-test or a Pearson's correlation test (depending on responses to the follow-up questions). If the user has selected one continuous and one categorical variable, the platform might recommend an ANOVA test or a two-sample t test.
Test launch: The user could then click on a “Launch test” button to run the recommended statistical test. The platform would then process the data and provide the results of the test, along with any relevant statistical measures such as p-values or confidence intervals.

Current systems for statistical testing, such as statistical software packages or online platforms, often require users to have some knowledge of statistics and data analysis in order to select and run the appropriate tests. They may also require users to enter their data manually and specify the type of variables they have, which can be time-consuming and error-prone. In contrast, the new platform provides clear prompts and guidance to help lay users select the appropriate statistical test for their data and specifies the type of variables for them. This could make the process of statistical testing more efficient and user-friendly for lay users, helping them to easily and accurately analyze their data without the need for extensive technical knowledge.

In addition, this platform introduces an innovative new way of recoding both categorical and continuous variables. For continuous variables, this new way of recoding continuous variables involves graphically representing the data in the form of a cylinder which displays the five number summary of the data (minimum, first quartile, median, third quartile, and maximum). To create categories, the user simply clicks inside the cylinder to introduce an arrow and a number-containing box on top of the arrow showing the location of the cut. The user can edit the numbers in the boxes to specify where they want the cut-offs to be placed and specify whether the cut-offs should be in the group above, below, or in a group of their own. For example, if the user wanted to create three categories, they could click twice to introduce two arrows and boxes, and then specify the cut-off points for each of the three categories. This approach could be easier for lay people to understand and use compared to current approaches, such as using statistical software or programming languages or data visualization software, as it provides a simple and intuitive graphical interface for creating categories. It could also be more efficient for data analysis and visualization, as it allows users to quickly and easily create and modify categories as needed.

The new approach for recoding categorical variables involves allowing users to drag and drop boxes representing the categories into one another to create new categories or merge existing categories. To edit the names or labels of the categories, users can simply click on the name or label and type in the new name or label. This provides a simple and intuitive interface for recoding categorical variables, which may be easier for laypeople to understand and use compared to current approaches such as using statistical software or programming languages or data visualization software. The new approach does not require any technical knowledge or coding skills and allows users to quickly and easily recode and label categories as needed, making it more efficient for data analysis and visualization.

The new approach for recoding individual variables described above could also be used to create a composite variable by dragging and merging categories across and within multiple variables. To create a composite variable using this approach, you would start by selecting two parent variables and dragging and dropping the categories of these variables into one another to create new categories or merge existing categories. For example, if you had two parent variables, “Gender” and “Age Group,” you could drag and drop the categories of these variables to create new categories such as “Female 18-24,” “Male 18-24,” “Female 25-34,” and “Male 25-34.” You could then edit the names or labels of these categories as desired. If you had more than two parent variables, you would start by creating a composite variable using the first two parent variables, and then use the newly created composite variable in combination with the next parent variable. This process would continue until all variables have been used. For example, you could create a composite variable using the “Gender” and “Age Group” variables, and then use this composite variable in combination with a third variable, such as “Income Level,” to create new categories such as “Female 18-24 Low Income,” “Male 18-24 Low Income,” “Female 25-34 Low Income,” and “Male 25-34 Low Income.”

One can also combine a continuous variable with a categorical variable, or two continuous variables with each other, by first splitting the continuous variables into categories using the arrow method described previously and then combining them with the categorical variables or other continuous variables using the drag and drop method. For example, suppose you have a continuous variable “Income” and a categorical variable “Occupation.” To create a composite variable using these two variables, you could first split the “Income” variable into categories using the arrow method. For example, you could split the “Income” variable into three categories: “Low Income” (below the first quartile), “Medium Income” (between the first and third quartiles), and “High Income” (above the third quartile). Then, you could combine these categories with the categories of the “Occupation” variable using the drag and drop method to create new categories such as “Low Income Salesperson,” “Medium Income Salesperson,” and “High Income Salesperson,” or “Low Income Engineer,” “Medium Income Engineer,” and “High Income Engineer,” etc. Alternatively, suppose you have two continuous variables, “Income” and “Education Level.” To create a composite variable using these two variables, you could first split both variables into categories using the arrow method. For example, you could split the “Income” variable into three categories as described above, and split the “Education Level” variable into four categories: “Low Education” (below the first quartile), “Medium Low Education” (between the first and second quartiles), “Medium High Education” (between the second and third quartiles), and “High Education” (above the third quartile). Then, you could combine these categories with each other using the drag and drop method to create new categories such as “Low Income Low Education,” “Low Income Medium Low Education,” “Low Income Medium High Education,” and “Low Income High Education,” or “Medium Income Low Education,” “Medium Income Medium Low Education,” “Medium Income Medium High Education,” and “Medium Income High Education,” etc. This new approach for combining continuous variables with categorical variables or with each other using the arrow and drag and drop methods could be useful for data analysis and visualization, as it allows users to easily and intuitively create new categories by splitting and combining continuous variables with categorical variables or with each other. It could also be more efficient and user-friendly compared to current approaches, such as using statistical software or programming languages, which may require technical knowledge and can be more time-consuming.

The platform as per its further embodiments includes a range of advanced statistical analysis tools and features that are designed to be user-friendly and intuitive for lay users. These tools and features are grouped into different categories, such as selections allowing the user to automatically generate tables for the distribution of the population, mean estimates, prevalence estimates, and regression analysis. To use the platform, users would first select the type of analysis they want to perform from the available options. For example, if the user wanted to perform a regression analysis, they could select “Linear regression” from the list of options under the “Create tables” or “Create figures” tabs. The platform would then prompt the user to select the outcome variable, predictor variables, and whether they want to analyze the whole population or a subset of the population. Based on the user's selections, the platform would automatically perform the regression analysis and generate a well-formatted table or figure with the results. This approach could potentially be novel compared to current tools and platforms, as it is specifically designed to be accessible and easy to use for lay users who may not have a strong background in statistics or data analysis. Many existing statistical software packages and online platforms require users to have some knowledge of statistics and data analysis in order to perform statistical tests and generate tables and figures, and may not offer such a wide range of tools and features in a single platform. In contrast, the new platform provides clear prompts and guidance to help lay users select the appropriate statistical analysis tools and input their data, and automatically generates well-formatted tables or figures with the results.

The platform described above includes a feature that automatically classifies variables into one of four groups: count, continuous, categorical, and dates. This classification is based on the nature of the data and is intended to help users select the appropriate variables for different tasks and analyses. For example, if the user wanted to perform a binary logistic regression analysis, the platform would automatically examine the nature of the required input and allow only binary variables to be selected as the outcome. This would protect the user from selecting a continuous or categorical variable as the outcome, which would result in an invalid analysis.

This feature is novel compared to current tools and platforms, as many existing statistical software packages and online platforms do not offer such a high level of variable classification and validation to help users select appropriate variables for different tasks and analyses. In some cases, users may have to manually check the nature of their variables and ensure that they are selecting appropriate variables for their analysis, which can be time-consuming and error-prone. In contrast, the new platform automatically classifies variables and allows only eligible variables to be selected for specific tasks, helping users to more easily and accurately analyze their data and avoid common errors or mistakes. This could make the process of statistical analysis more efficient and user-friendly for lay users, helping them to easily and accurately analyze their data without the need for extensive technical knowledge.

The platform includes a feature that allows users to analyze both complex survey data that have weights, as well as unweighted data. This is a useful feature, as it allows users to work with different types of data and choose the most appropriate analysis method based on the characteristics of their data. To use this feature, the user specifies the data type at the point of data ingestion, but can change the specification at any point if needed. If analyzing complex survey data, the user can then select the weighting, clustering, and stratification variables as needed. The platform remembers the initial selection unless the user wishes to change it, which saves the user from having to specify the data type and other relevant adjustment variables every single time. This feature is novel compared to current tools and platforms, as many existing statistical software packages and online platforms do not offer the ability to easily analyze both complex survey data and unweighted data in a single platform. In some cases, users may have to use different software or analysis methods depending on the type of data they are working with, which can be time-consuming and require additional technical knowledge. In contrast, the new platform allows users to easily and seamlessly switch between different data types and analysis methods as needed, helping them to more efficiently and accurately analyze their data.

The platform includes a feature that modernizes data analysis by allowing users to easily assess and visualize their data. In the variable window, each variable is displayed with a “+” beside it, and clicking on that plus allows the user to see all the categories a variable has along with the number of missing values (for continuous or discrete variables, it shows the 5-number summary for each variable). This eliminates the need for the user to analyze the data just to see basic counts. Furthermore, beside each variable is a set of three dots, which the user can select to view options. To visualize a variable, the user simply needs to use the three dots to select “Visualize,” and the platform will automatically generate a figure based on its knowledge of the variable type. This approach is novel compared to current tools and platforms, as many existing statistical software packages and online platforms require users to take a number of additional steps to visualize their data. For example, users may have to select specific visualization tools or functions, specify the type of plot or chart they want to create, and input their data manually. These additional steps can be time-consuming and require users to have some knowledge of statistics and data analysis. In contrast, the innovative process described above allows users to easily visualize their data with a few simple clicks, without the need for extensive technical knowledge or additional steps. This could make the process of data visualization more efficient and user-friendly for lay users, helping them to more easily and accurately understand and analyze their data.

The platform has a history module which tracks every single analysis ran, remembering the outcomes, predictors, subpopulations, and any other parameters selected in the initial run. The same applies to variable transformation or generation. The user can therefore review analysis that may have happened years ago and can rerun any analysis with a single click. Also deleted variables can be recovered from the history module as well. Having such a history module that tracks every analysis run can be extremely useful for a number of reasons. First and foremost, it allows users to review and understand the work that has been done on a particular dataset. This can be especially important in collaborative environments, where multiple people may be working on the same data and it is important to keep track of what has been done. Additionally, the ability to recover deleted variables and rerun previous analyses with a single click can save time and effort, as it allows users to quickly access and reuse previous work rather than having to start from scratch. One of the main benefits of having a history module is that it allows users to easily reproduce and validate previous work. This is especially important in scientific and research settings, where reproducibility is a key principle. By being able to see exactly what analyses were run and with what parameters, users can ensure that they are following the same steps as previous analyses, which can help to reduce the risk of errors and increase the reliability of the results. In contrast, many current tools do not have such robust history tracking capabilities. While some tools may have some basic history tracking features, they may not be as comprehensive. This can make it more difficult for users to reproduce and validate previous work, as they may not have access to all of the necessary information. It can also make it more difficult for users to understand the work that has been done on a particular dataset, as they may not have a complete record of the analyses that have been run.

The new platform's features of being able to merge datasets using unique IDs, same-family IDs, or multifamily cluster IDs can be particularly useful in addressing the issue of unique IDs at multiple levels of hierarchy. By allowing users to specify which type of ID they are using (e.g., individual, family, or household), the platform can help to clarify which data should be linked together when merging datasets. This can make it easier for users to accurately merge datasets that contain data at multiple levels of hierarchy, and can help to improve the accuracy and reliability of the analysis. Additionally, by being able to merge an unlimited number of datasets, users can get a more complete and comprehensive view of the data, which can help to improve the accuracy and effectiveness of their analysis. Finally, the merge feature has a ‘Preview feature’ which the user can click on to see whether the procedure will work and the degree of commonality among the datasets.

Furthermore, the platform allows the user to append an unlimited number of datasets to the current one which also has a preview feature. After the datasets are appended, the Chisquares platform will display variables common to all datasets with a green dot and those not common with a red dot. This will help the user know which variables to use in pooled analysis without having to perform laborious cross-tabulations.

Sensitivity analysis at a click: when an analysis is run and the results are output, the display suggests some sensitivity analysis automatically. The option “change inputs” is common to every single output, while additional sensitivity analyses are custom for specific analysis. For example, if the user ran a linear regression analysis, the suggested sensitivity analyses include the following “rerun with log-transformed outcome”, “rerun with square row transformed outcome”, “rerun with exponentially-transformed outcome”, or “change inputs”. The ability to automatically suggest sensitivity analysis when an analysis is run and display the results can be extremely useful for a number of reasons. First, sensitivity analysis is an important tool for evaluating the robustness of an analysis and understanding how sensitive the results are to changes in the input data or assumptions. By suggesting sensitivity analyses automatically, the platform can help users to more easily and quickly explore the sensitivity of their results. This can be especially useful in cases where users may not be familiar with sensitivity analysis or may not have thought to conduct it on their own. Second, the option to “change inputs” that is common to every single output can be useful for allowing users to easily and quickly explore how different input choices might impact the results of an analysis. This can help users to better understand the factors that influence the results and can be especially useful for identifying any potential sources of bias or error in the analysis. Finally, the ability to suggest custom sensitivity analyses for specific types of analysis (e.g., linear regression) can be particularly useful for helping users to more fully understand the results of their analysis.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

I: A system and method providing advanced features of data collection, sampling, and analysis wherein:
As per claim 1, wherein tools and features are grouped into multiple categories, such as distribution of the population, mean estimates, prevalence estimates, and regression analysis.
As per claim 1, wherein the platform provides clear prompts and guidance to help lay users select the appropriate statistical analysis tools and input their data and automatically generate well-formatted tables or figures with the results.
As per claim 1, wherein the platform automatically classifies variables into one of four groups: count, continuous, categorical, and dates. This classification is based on the nature of the data and is intended to help users select the appropriate variables for different tasks and analyses. For example, if the user wanted to perform a binary logistic regression analysis, the platform would automatically examine the nature of the required input and allow only binary variables to be selected as the outcome. This would protect the user from selecting a continuous or categorical variable as the outcome, which would result in an invalid analysis.
As per claim 1, wherein the platform allows users to analyze both complex survey data that have weights, as well as unweighted data. This feature, allows users to work with different types of data and choose the most appropriate analysis method based on the characteristics of their data.
As per claim 1, wherein the user specifies the data type at the point of data ingestion, but can change the specification at any point if needed. If analyzing complex survey data, the user can also select the weighting, clustering, and stratification variables as needed.
As per claim 1, wherein the platform remembers the initial selection unless the user wishes to change it, which saves the user from having to specify the data type and other relevant variables every single time.
As per claim 1, wherein the platform allows users to easily and seamlessly switch between different data types and analysis methods as needed, helping them to more efficiently and accurately analyze their data.
As per claim 1, wherein the data analysis allows users to easily assess and visualize their data. In the variable window, each variable is displayed with a “+” beside it, and clicking on that plus allows the user to see all the categories a variable has along with the number of missing values.
As per claim 1, wherein each variable has a set of three dots beside it, which the user can select to view options. To visualize a variable, the user simply needs to use the three dots to select “Visualize,” and the platform will automatically generate a figure based on its knowledge of the variable type.
As per claim 1, wherein the innovative process described above allows users to easily visualize their data with a few simple clicks, without the need for extensive technical knowledge or additional steps. This could make the process of data visualization more efficient and user-friendly for lay users, helping them to more easily and accurately understand and analyze their data.
As per claim 1, wherein the platform has a history module that tracks every single analysis ran, remembering the outcomes, predictors, subpopulations, and any other parameters selected in the initial run.
As per claim 1, wherein the same applies to variable transformation or generation. The user can therefore review analysis that may have happened years ago and can rerun any analysis with a single click. Also deleted variables can be recovered from the history module as well. Having such a history module that tracks every analysis run can be extremely useful for a number of reasons. First and foremost, it allows users to review and understand the work that has been done on a particular dataset. This can be especially important in collaborative environments, where multiple people may be working on the same data and it is important to keep track of what has been done.
As per claim 1, wherein the ability to recover deleted variables and rerun previous analyses with a single click can save time and effort, as it allows users to quickly access and reuse previous work rather than having to start from scratch. One of the main benefits of having a history module is that it allows users to easily reproduce and validate previous work.
As per claim 1, wherein the new platform's features of being able to merge datasets using unique IDs, same-family IDs, or multifamily cluster IDs can be particularly useful in addressing the issue of unique IDs at multiple levels of hierarchy.
As per claim 1, wherein users specify which type of ID they are using (e.g., individual, family, or household), the platform can help to clarify which data should be linked together when merging datasets. This can make it easier for users to accurately merge datasets that contain data at multiple levels of hierarchy, and can help to improve the accuracy and reliability of the analysis. Additionally, by being able to merge an unlimited number of datasets, users can get a more complete and comprehensive view of the data, which can help to improve the accuracy and effectiveness of their analysis.
As per claim 1, wherein the merge feature has a ‘Preview feature’ which the user can click on to see whether the procedure will work and the degree of commonality among the datasets.
As per claim 1, wherein the platform allows the user to append an unlimited number of datasets to the current one. It also has a preview feature. After the datasets are appended, the platform will display variables common to all datasets with a green dot and those not common with a red dot.
As per claim 1, wherein the three red dots beside each variable have been changed to red or green as necessary to reflect whether the variable in question was in some or all datasets respectively.
As per claim 1, wherein the main analysis is run and the results are output, the display suggests some sensitivity analysis automatically. The option “change inputs” is common to every single output, while additional sensitivity analyses are custom for specific analysis. For example, if the user ran a linear regression analysis, the suggested sensitivity analyses include the following “rerun with log-transformed outcome”, “rerun with square row transformed outcome”, “rerun with exponentially-transformed outcome”, or “change inputs”.
As per claim 1, wherein the ability to automatically suggest sensitivity analysis when an analysis is run and display the results can be extremely useful for a number of reasons. First, sensitivity analysis is an important tool for evaluating the robustness of an analysis and understanding how sensitive the results are to changes in the input data or assumptions.
As per claim 1, wherein by suggesting sensitivity analyses automatically, the platform can help users to more easily and quickly explore the sensitivity of their results. This can be especially useful in cases where users may not be familiar with sensitivity analysis or may not have thought to conduct it on their own. Second, the option to “change inputs” that is common to every single output can be useful for allowing users to easily and quickly explore how different input choices might impact the results of an analysis. This can help users to better understand the factors that influence the results and can be especially useful for identifying any potential sources of bias or error in the analysis.
As per claim 1, wherein the ability to suggest custom sensitivity analyses for specific types of analysis (e.g., linear regression) can be particularly useful for helping users to more fully understand the results of their analysis.
